(19) United States
(12) Patent Application Publication
(10) Pub. No.: US 2008/0196768 A1
(43) Pub. Date: Aug. 21, 2008

(54) Combination tethered protective-cap and pressure cap

(75) Inventor: Daniel J. Steffan, Erie, PA (US)

Correspondence Address: OLIFF & BERRIDGE, PLC, P.O. BOX 320850, ALEXANDRIA, VA, 22320-4850, US

(73) Assignee: ALLIANCE PLASTICS, Erie, PA (US)

(21) Appl. No.: 11/707,887

(22) Filed: Feb. 20, 2007

(51) Int. Cl. F16K 35/00

(52) U.S. Cl. 137/232

(57) ABSTRACT

A capping system for a container having a valve stem, comprising: a flexible tether having a first end region, a second end region, and a central region between the first and second end regions. A first connector is located at the first end region for attaching the tethered capping system to the container. A first cap is located in one of the central and second end regions and sized to frictionally fit over the valve stem. The other of the central and second end regions has a second connector for attaching a second cap to the tether. The second cap may be a threaded pressure cap for correspondingly engaging threads located on the valve stem. In alternative embodiments, the first connector can be located in the central region, and the first cap and second connector for the second cap are located in the first and second end regions.

### BACKGROUND

This invention relates generally to a tethered protective capping system for covering the end of a valve, and more particularly, to a tethered combination friction fit protective cap and threaded pressure cap for use on an automotive air conditioning system.

Air conditioning systems, and other subsystems, for automotive use are manufactured in multiple manufacturing plants for final assembly at an automotive manufacturing plant. After the subassembly is manufactured, the unprotected valve mechanism may be exposed to debris as well as subject to possible physical damage during delivery to the automotive manufacturing plant. In order to minimize damage, a friction fit protective cap is placed over the valve stem before it is shipped to its final destination.

Upon arrival at the automobile plant and after installation in an automobile, the protective cap is discarded to allow access to the internal valve mechanism. After pressurizing the air conditioning system with refrigerant, a threaded pressure cap is installed as a secondary boundary in order to capture any refrigerant that may leak past the valve mechanism. After the automobile is sold and put into use, the installed pressure cap minimizes unintentional leakage past the valve mechanism.

Conventionally, untethered protective capping systems may slip off or become lost during shipment which results in unnecessary delays as replacement caps must be found and installed. If, at the time of final assembly, pressure caps are out of stock, an assemblyman may be tempted to pressurize the system without installing a pressure cap. Furthermore, the act of having to find a pressure cap after charging the system can consume a significant amount of time. Lastly, the use of conventional untethered caps requires the stocking of multiple types of caps at multiple locations which also leads to assembly line inefficiencies.

Even after an automobile is manufactured, the use of conventional untethered caps may result in a pressure cap coming loose and getting lost. If the owner of the automobile or a repairman were to notice the missing cap, he or she would not be able remedy the situation without purchasing or locating a replacement cap. This is of particular concern in automobile air conditioning systems, as environmental awareness of the depletion of the ozone layer has stressed the importance of preventing the leakage of chlorofluoro compounds (“CFC”) into the atmosphere.

### SUMMARY

An object of the invention is to provide a tethered protective cover for a valve stem that is easy to install and remove, and tethered to the valve stem to ensure it is not lost.

A further object of the invention is to provide a threaded pressure cap attached to the protective cap to minimize installation time after the subsystem has been charged and to ensure the pressure cap is not lost after installation.

A further object of the invention is to provide a capping system such that the pressure cap is always available to be reinstalled after maintenance to the system, thereby preventing leakage of refrigerant or CFC containing compounds to the atmosphere.

A further object of the invention is to provide a capping system using conventional resin molding techniques that requires minimal assembly and thereby minimizing production costs and complexity.

Accordingly, a protective capping system is desired that can be tethered to a valve body and that contains multiple caps: a protective cap that is frictionally fit over a valve stem so as to be installed and removed quickly, and a threadably engaged cap for covering the valve stem and capable of withstanding a possible high pressure differential caused by unintentional leakage from the pressurized subsystem.

A protective capping system for a valve stem includes a flexible tether with a first end region, a second end region and a central region located between the first and second end regions. A first connector for attaching the protective capping system to the valve body is located at one of the central or end regions and may comprise a long narrow loop to be fit over a valve stem so as to frictionally engage the valve neck.

A first cap is located in one of the remaining central or end regions and is sized to frictionally fit over the charging valve so as to be easily installed and removed. The remaining region has a second connector for rotatably attaching a second cap to the tether, the second cap having threads to engage corresponding threads on the valve stem.

The first cap has first and second ends, the first end being tapered so as to frictionally engage the inside of the second cap. The second end has an internal bore, the diameter of which corresponds to the outside diameter of a corresponding valve stem. A partition running transverse the first cap prevents dust and debris from entering the valve mechanism.

The threaded region of the second cap is designed to correspond to the threads on a valve stem. The second cap may further contain an internal gasket or o-ring to engage the valve stem and prevent any accidental leakage from the pressurized subsystem. The second cap should be made from a material harder than the flexible resin used in the tether and first cap, and selected so as to withstand a high pressure differential that may be caused by gases leaking past a faulty valve mechanism.

The outside of the second cap should have an annular region defined either by a groove along the outside circumference of the cap or by alternating flanges spaced apart along the circumference of the second cap.

The second connector may further include either a ring that snuggly fits around the annular space on the circumference of the second cap, a pin and ring connector, a snap ring connector, or any other means known in the art for rotatably attaching the second cap to the tether.

In use, the first cap covers the valve stem of an empty container to protect the valve stem during transit of the container. The first cap is removed after transit, the container is filled, and then the second cap is placed on the valve stem to prevent leakage.

These and other objects, advantages and salient features are described in or apparent from the following description of exemplary embodiments.

### BRIEF DESCRIPTION OF THE DRAWINGS

Exemplary embodiments of the invention will be described with reference to the following drawings, wherein like numerals represent like parts, and wherein:

FIGS. 1A and 1B are perspective views of one embodiment of a protective capping system;

FIGS. 2A and 2B are perspective views of an alternative embodiment of the protective capping system;

FIGS. 3A and 3B are perspective views of an alternative embodiment of the protective capping system;

FIGS. 4A to 4D are are detailed perspective views illustrating the installation of the pressure cap into the second connector;

FIGS. 5A and 5B are side views illustrating alternate embodiments of the pressure cap;

FIG. 5C is a side view of the protective cap;

FIGS. 6A to 6C are perspective views illustrating alternative embodiments of the first connector;

FIGS. 7A to 7D are perspective views illustrating alternate embodiments of the first connector of the protective capping system;

FIG. 8 is a cross-sectional view of the pressure cap; and

FIG. 9 is a perspective view of the second embodiment illustrating how the pressure cap interacts with the valve stem.

### DETAILED DESCRIPTION OF EMBODIMENTS

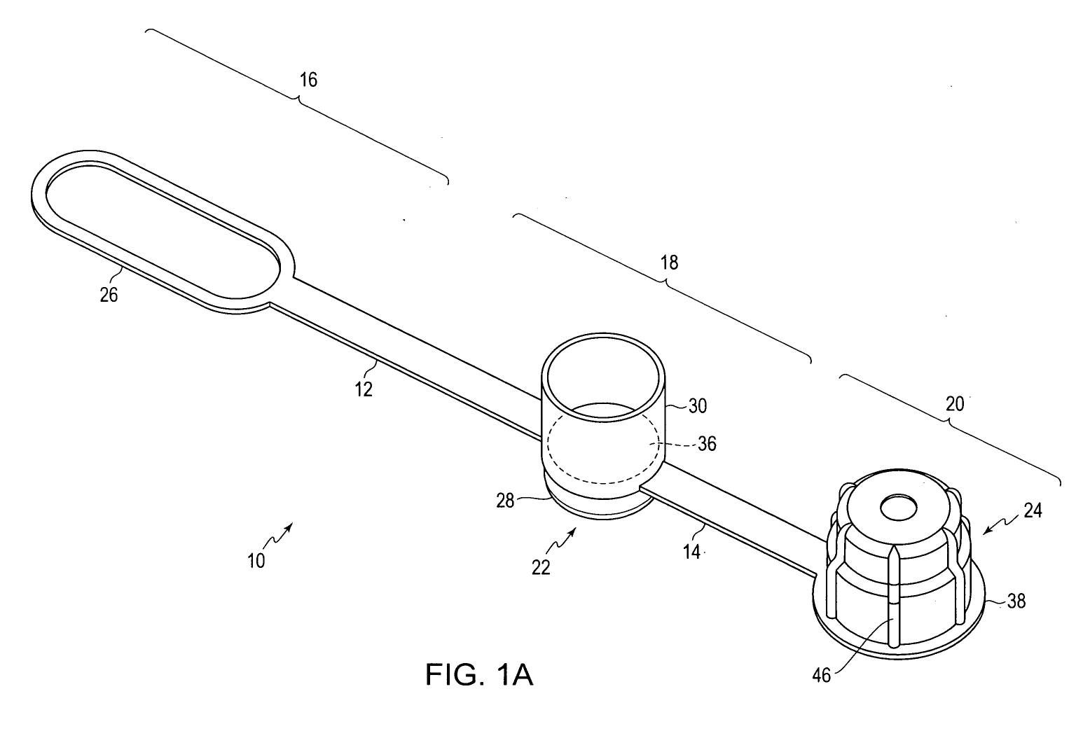

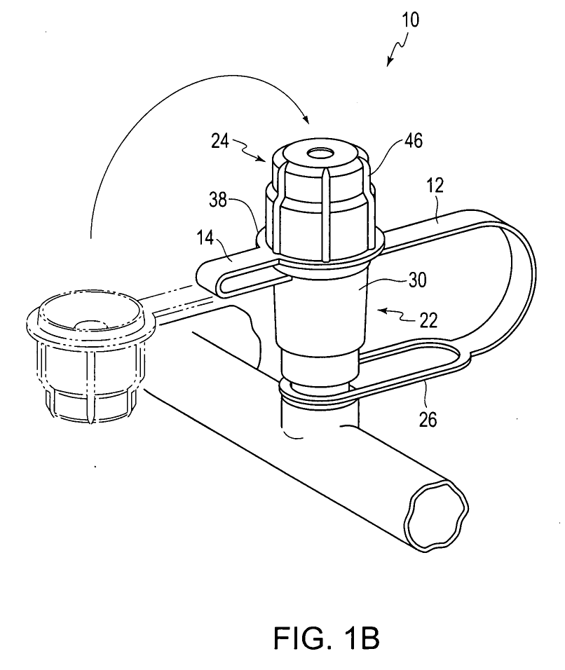

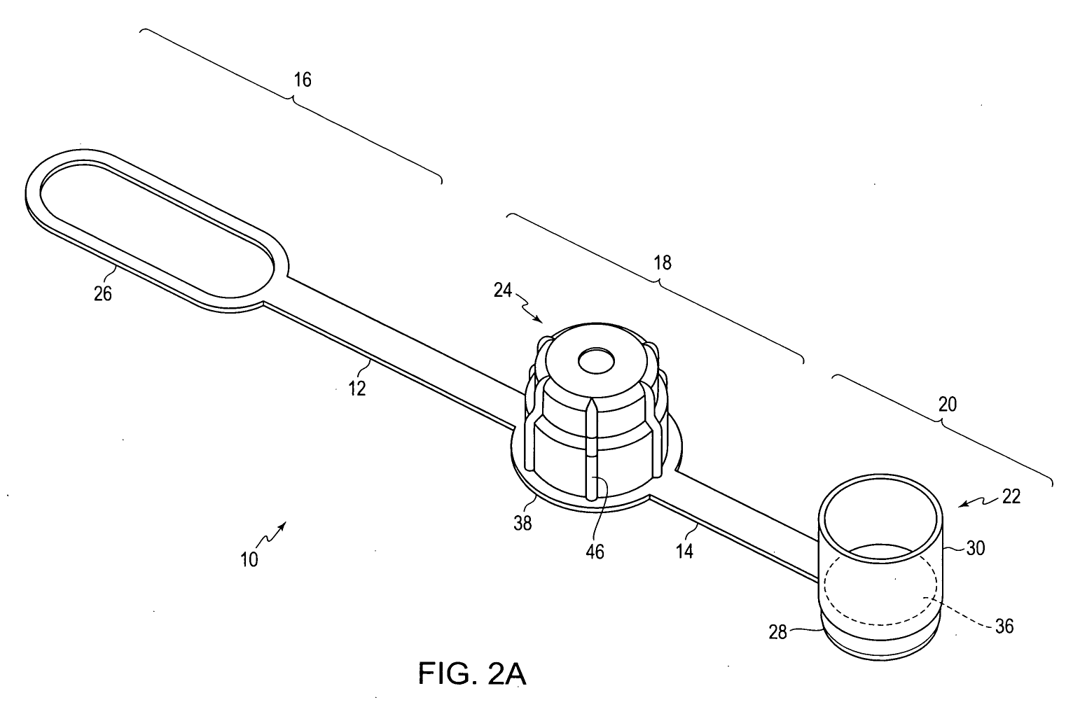

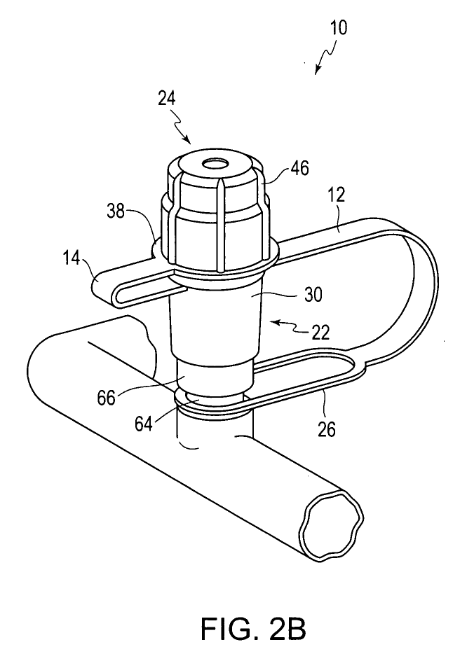

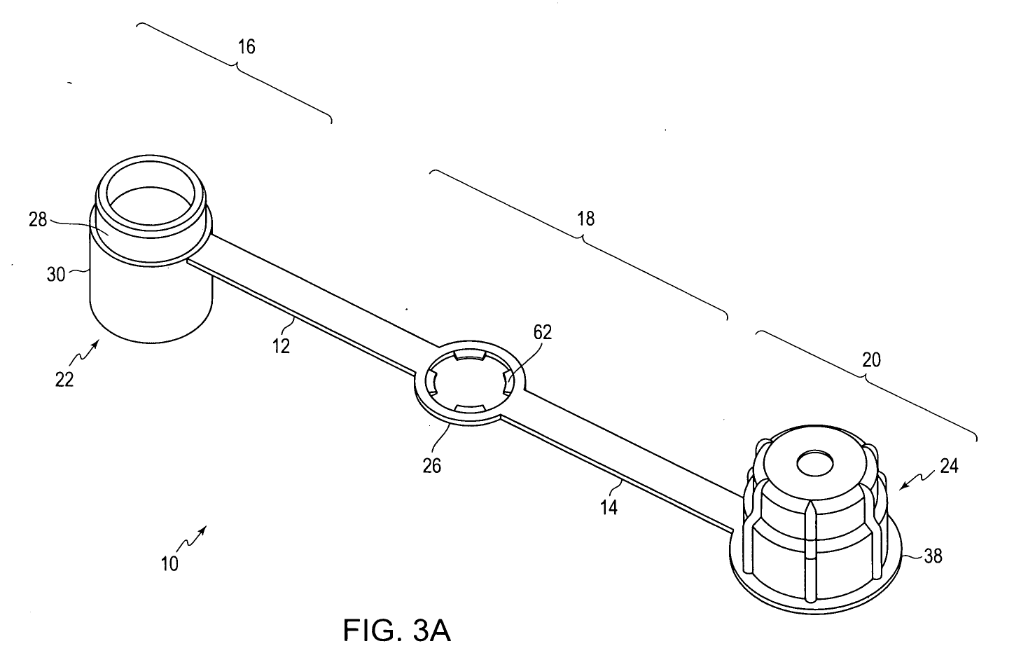

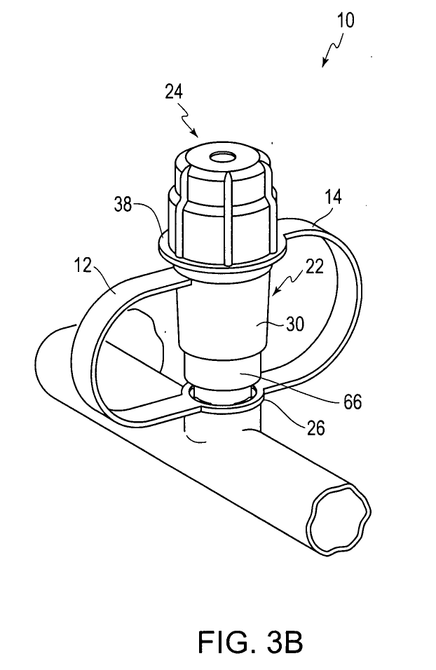

FIGS. 1A and 1B show an exemplary embodiment of the invention. The tethered capping system 10 includes a flexible tether having a first tether portion 12 and a second tether portion 14. The flexible tether includes a first end 16, a central region 18 and a second end region 20 opposite the first end. In FIG. 1A, a protective cap 22 is located in the central region 18 and a pressure cap 24 is located in the second end region 20. In an alternate embodiment of FIG. 2A (discussed in more detail below), the protective cap 22 is located in the second end region 20 and the pressure cap 24 is located in the central region 18. In a further embodiment, as illustrated in FIG. 3A, the protective cap 22 and pressure cap 24 are located at opposite end regions, 16 and 20, and the first connector is located in the central region 18.

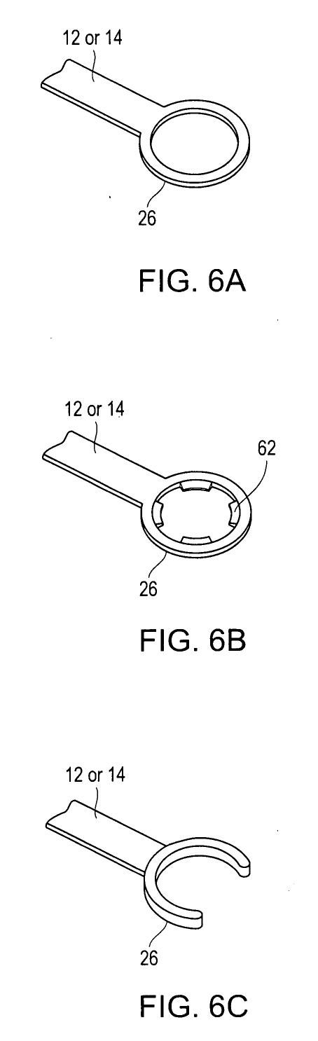

In a first embodiment, the first end 16 includes a first connector 26, which can be a ring as shown in FIG. 6A, designed so as to fit over a valve stem and frictionally engage a neck of the valve stem. In FIG. 1A, the first connector 26 is connected to the protective cap 22 by way of the first tether portion 12 which is dimensioned so that the cap located in the central region 18 can easily fit over the valve stem while first connector is looped over the valve stem, as shown in FIG. 1B.

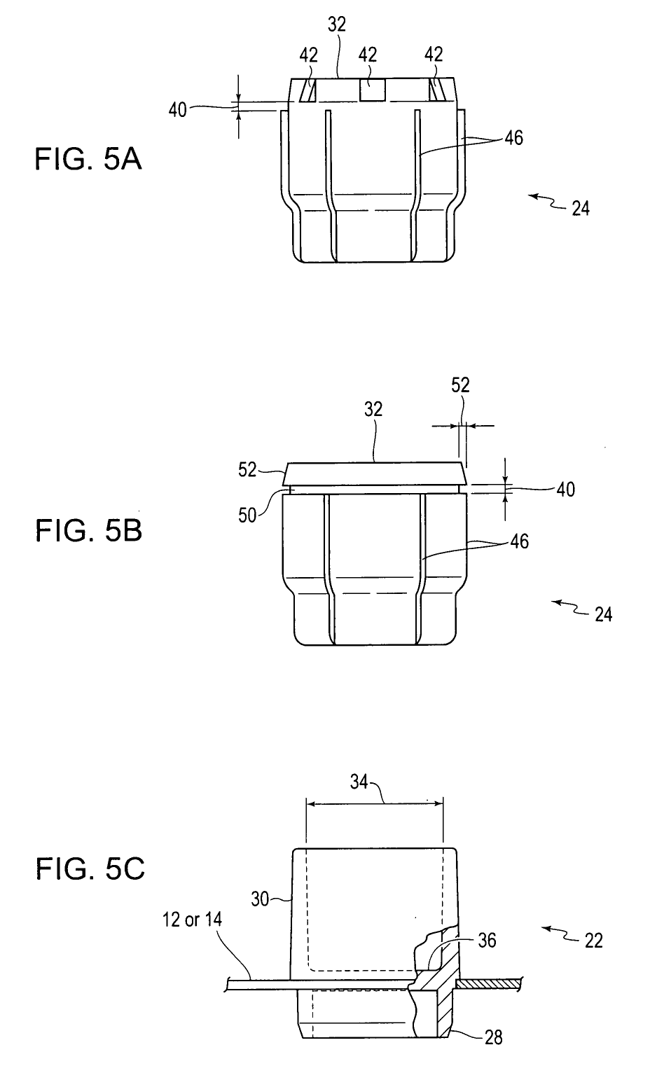

FIG. 5C is a detailed view of the protective cap 22 which has a tapered region 28 and a straight region 30. Tapered region 28 is dimensioned so as to frictionally fit in an open end 32 of the pressure cap 24. FIG. 1B illustrates the pressure cap 24 installed onto the tapered region 28 of the protective cap 22. The straight region 30 has a bore dimensioned so that the internal diameter 34 closely corresponds to an outer dimension of the valve stem. The protective cap 22 is dimensioned so as to remain frictionally fit over the valve stem during transportation, to protect the valve threads during transit. However, the protective caps 22 should be loose enough to require minimal installation and removal effort so as to not adversely impact the assembly line efforts. An internal partition 36 runs transverse the cross section of the protective cap 22. The internal partition 36 keeps dust and debris from damaging threads of the valve mechanism during transportation of the subassembly. The protective cap 22 is further connected to pressure cap 24 by the second tether portion 14 which is dimensioned so that the pressure cap 24 can easily fit over the protective cap as shown in FIG. 1B.

As illustrated in FIG. 1A, the second tether portion 14 connects to the pressure cap 24 by way of a second connector 38 located on the second end 20 of the protective capping system 10. The second connector 38 includes a circular ring dimensioned to rotatably fit into a defined annular region 40 on the outside of the pressure cap 24. FIG. 5A illustrates that the defined annular region 40 is defined by a space between alternating tapered flanges 42 and flanges 46 located around the circumference of the pressure cap 24. The ends of the tapered flanges 42 and flanges 46 are spaced apart so as to accommodate the thickness of the second connector 38, as shown in FIG. 1A, and thereby provide a means for rotatably connecting the pressure cap 24 to the second tether portion 14.

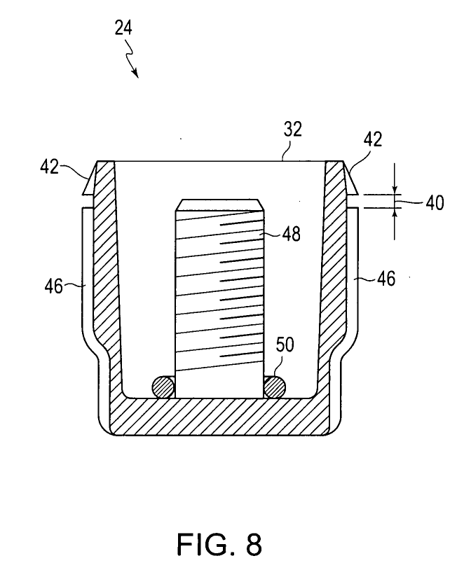

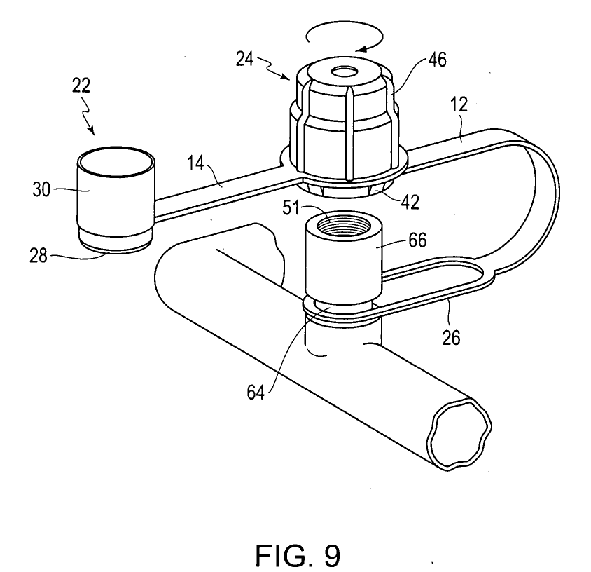

As illustrated in FIG. 8, the pressure cap 24 further contains internal threads 48 and a gasket or o-ring 50 that corresponds to the particular valve on which the capping system 10 is being installed. In the exemplary embodiment, the pressure cap 24 contains a threaded internal spool 48 situated coaxially with the pressure cap 24 such that the threads engage corresponding threads on the valve mechanism 51. When the pressure cap 24 is installed, the o-ring 50 is compressed tightly against the valve mechanism 51 to further protect against unintentional leakage of CFC containing refrigerant into the environment.

The protective cap 22 and tether portions 12 and 14 are of a unitary construction, molded of a flexible resin using conventional injection molding techniques so as to minimize assembly steps. The material selected for the tether and protective cap should be soft enough to absorb any energy impacts on the valve stem, and to provide a predetermined amount of flex such that the second connector 38 can tightly slip over the tapered flanges 42. The pressure cap 24 is made of a harder material than tether portions 12, 14 and the protective cap 22, preferably of a resin containing at least 33% glass fiber by volume. Furthermore, the material selected for the pressure cap should be hard enough to withstand the possible high differential pressure caused by leakage past the valve stem.

It should be noted that the protective cap and pressure cap have opposing design considerations. As stated previously, the protective cap should be easily installed and removed to have a minimal impact on the assembly line, and made of a material soft enough to absorb any impact energy during transportation. The pressure cap cannot be used during the initial shipping period because it adds too much time to the installation and removal process, and the harder material that its made of would not adequately absorb impact energy to protect the valve mechanism. Similarly, the soft material used for the protective cap would deform under a high pressure differential and therefore would not provide a sufficient barrier against leakage from the pressurized system.

A second embodiment of the capping system 10 is shown in FIGS. 2A and 2B, in which the pressure cap 24 is installed in the central region 18 and the protective cap 22 molded in the second end 20.

A third embodiment of the capping system 10 is shown in FIGS. 3A and 3B, in which the first connector 26 is located in the central region 18, and the pressure cap 24 and protective cap 22 are located at opposite ends. Selection among the exemplary, second or third embodiments depends on the particular valve being protected. Furthermore, the installation, operation and use of the second embodiment are similar to the exemplary embodiment already described.

Further embodiments may involve alternate defined annular regions 40, as shown in FIG. 5B. Instead of having alternating flanges, as shown in FIG. 5A, the pressure cap can have an annular groove 50 in the circumference of the pressure cap 24. The open end 32 includes a tapered section 52, or increase in radius away from the open end 32 so as to flex the second connector 38 and prevent it from slipping off once rotatably engaged in the annular region 40 as shown in FIGS. 1A through 2B.

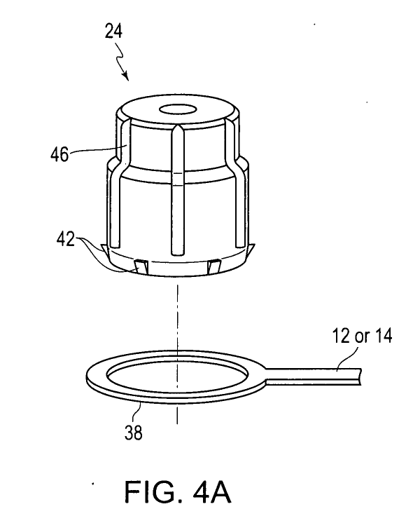

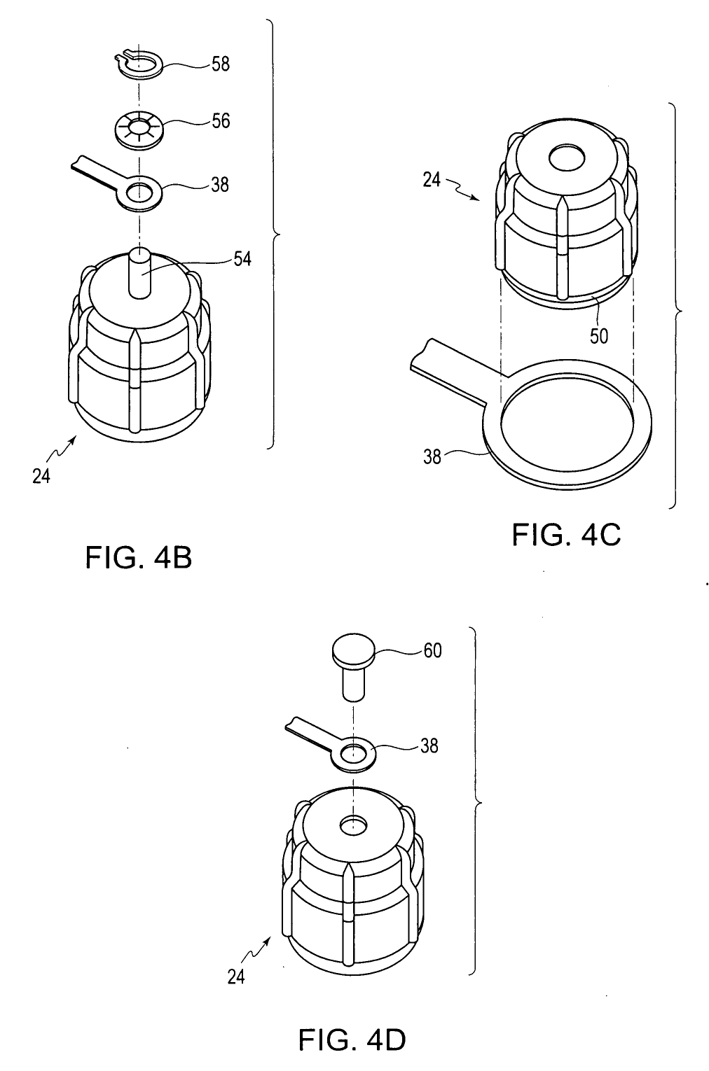

Further embodiments may involve alternates of the second connector 38 as shown in FIGS. 4B to 4D. Instead of having a ring interacting with the annular space defined between flanges as shown in FIG. 4A, FIG. 4B shows the flexible tether connected to the top of the pressure cap 24 by way of a ring 38 located at one of the central or end regions which slips over post 54 and is rotatably held to pressure cap 24 by way of washer 56 and snap ring 58. An alternate embodiment of the second connector is shown in FIG. 4C in which the second connector 38 is sized so as to slip over the open end 32 of the pressure cap 24 and rotatably engage groove 40. Another embodiment of the second connector is shown in FIG. 4D in which the second connector 38 is connected to the top of the pressure cap 24 by way of a ring 38 which is rotatably attached by pin 60.

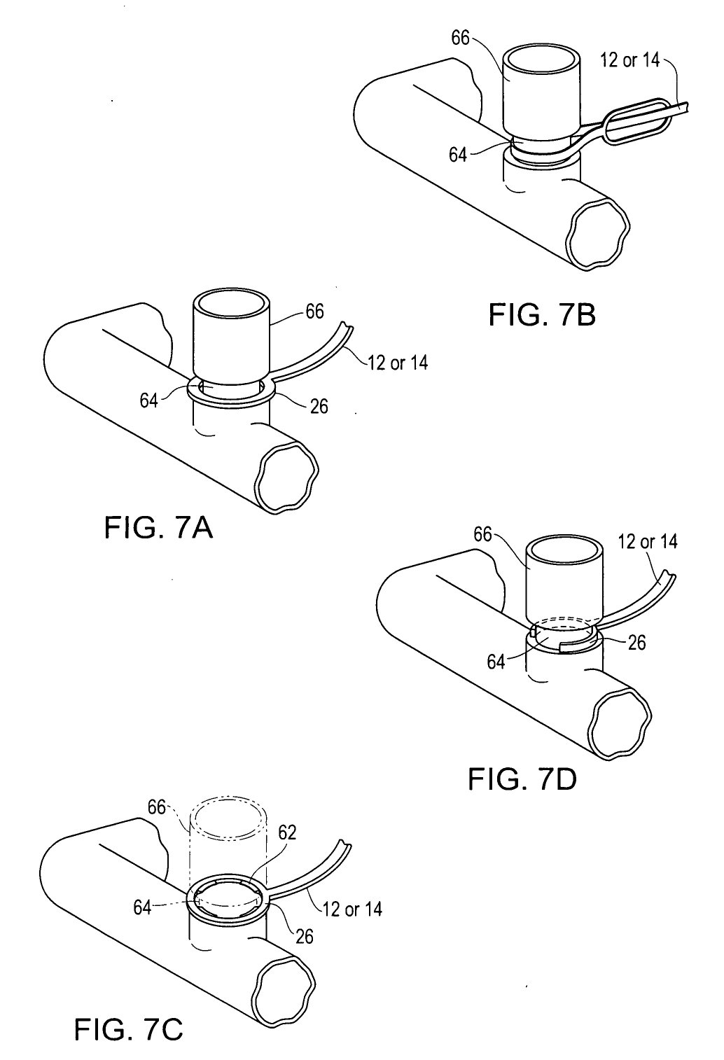

Further embodiments may involve alternate first connectors 26, as shown in FIGS. 6B and 6C. In FIG. 6B, radial protrusions 62 can flex in a direction away from the open end 32 of the pressure cap to facilitate the manufacturing of the protective capping system 10 as shown in FIG. 7C. In FIG. 6C, a flexible clip is located at one of the first or second end regions and is dimensioned so as to fit around a valve neck 64, as shown in FIG. 7D, so that the resilient nature of the resin material firmly yet rotatably holds the tether around the valve neck 64. FIG. 7B depicts an embodiment with a ring located at one of the first or second end regions so that the flexible tether can wrap around a valve neck 64 and allow the opposite end region to pass through the first connector.

In operation and use, as shown in FIGS. 7A to 7D, after a subassembly (not shown) is manufactured at a first plant, the tethered capping system 10 must be installed on a charging valve 66 such that a first connector 26 connects the tethered capping system 10 to a valve neck 64.

The protective cap 22 is installed over the charging valve 66 to protect the valve against physical damage, dust and debris, and is frictionally fit over the valve stem to minimize installation and removal time. The pressure cap 24 is then installed over the protective cap 22 to protect it and so that it does not swing freely during transportation of the subassembly and thereby present an opportunity to pull the protective cap 22 off. If, during shipment, the tethered capping system were to come loose, it would become immediately apparent and easily remedied because the tethered capping system 10 would remain attached to the particular valve 66 to which it is to be reattached.

Upon arrival at the automotive plant, the subassembly is installed in an automobile. The protective cap 22 is then removed to allow temporary access to the valve mechanism 51. After a technician has charged the subassembly, the pressure cap 24 is separated from the protective cap 22 and installed onto the charging valve 66 such that the threads 48 of the pressure cap engage corresponding threads on the valve mechanism 51. Due to the engaging threads and the harder material used, the pressure cap is able to remain installed on the valve stem in the event of leakage.

After the automobile is put into use, if the pressure cap 24 were ever to come loose it would become immediately apparent to a technician or the owner and the situation could quickly be remedied. By tethering the capping system 10 to the charging valve 66, it is always conveniently replaced and therefore able to prevent the inadvertent leakage of refrigerant or CFC containing gases into the environment.

Lastly, other embodiments may encompass alternate means for connecting the first connector 26 to the valve 66. By increasing the first tether portion 12 and dimensioning the first connector 26 so that the pressure cap 24 and protective cap 22 can fit through, the capping system 10 can be installed around the valve neck 64 or a corresponding loop on the valve body (not shown). By looping the capping system 10 around the valve neck 64 and passing the second end 20 through the first connector 26, another means for attachment can be accomplished.

While the invention has been described in conjunction with the specific embodiments described above, many equivalent alternatives, modifications and variations may become apparent to those skilled in the art once given this disclosure. Accordingly, the exemplary embodiments of the invention as set forth above are considered to be illustrative and not limiting. Various changes to the described embodiments may be made without departing from the spirit and scope of the invention.

What is claimed is:

1. A capping system for a container having a valve stem, comprising:
a flexible tether having a first end region, a second opposite end region, and a central region between the first and second end regions;
a first connector located in one of the central or end regions for attaching the tether to the container;
a first cap located in a different one of the central or end regions sized to frictionally fit over the valve stem; and
wherein a second connector for attaching a second cap to the tether is located in a remaining one of the central or end regions.

2. The capping system of claim 1, wherein the first cap is integrally formed in one of the central and second end regions.

3. The capping system of claim 1, wherein the first cap has first and second ends, the first end being sized to frictionally fit over the valve stem, and the second end including a connecting portion for frictionally attaching the second cap to the first cap.

4. The capping system of claim 3, wherein the second cap is attached to the second connector, and the tether flexes to allow the second cap to be received within the connecting portion of the first cap.

5. The capping system of claim 1, wherein the second cap is rotatable relative to the second connector.

6. The capping system of claim 5, wherein the second cap is connected by way of a snap ring connector.

7. The capping system of claim 5, wherein the second cap is connected by way of a pin and ring connector.

8. A capping system for a container having a valve stem, comprising:
a flexible tether having a first end region, a second opposite end region, and a central region between the first and second end regions;
a first connector in the first end region for attaching the tether to the container;
a first cap located in the central end region and sized to frictionally fit over the valve stem;
a second connector in the second opposite end region; and
a second cap attached to the second connector, the first and second caps being attached to the tether.

9. The capping system of claim 8, wherein the first cap is integrally formed with the tether.

10. The capping system of claim 8, wherein the first cap has first and second ends, the first end being sized to frictionally fit over the valve stem, and the second end including a connecting portion for frictionally attaching the second cap to the first cap.

11. The capping system of claim 10, wherein the second cap is attached to the second connector, and the tether flexes to allow the second cap to be removably received within the connecting portion of the first cap.

12. The capping system of claim 8, wherein the second cap is rotatable relative to the second connector.

13. The capping system of claim 12, wherein the second cap is connected by way of a snap ring connector.

14. The capping system of claim 12, wherein the second cap is connected by way of a pin and ring connector.

15. The capping system of claim 8, wherein the tether and first cap are made of a flexible resin and the second cap is made of a less flexible resin containing at least 33% glass fiber.

16. A capping system for a container having a valve stem, comprising:
a flexible tether having a first end region, a second opposite end region, and a central region between the first and second end regions;
a first connector in the first end region for attaching the tether to the container;
a first cap located in the second end region and sized to frictionally fit over the valve stem; and
a second connector in the central region; and
a second cap attached to the second connector, the first and second caps being attached to the tether.

17. The capping system of claim 16, wherein the first cap is integrally formed with the tether.

18. The capping system of claim 16, wherein the first cap has first and second ends, the first end being sized to frictionally fit over the valve stem, and the second end including a connecting portion for frictionally attaching the second cap to the first cap.

19. The capping system of claim 16, wherein the second cap is rotatable relative to the second connector.

20. The capping system of claim 18, wherein the second cap is attached to the second connector, and the tether flexes to allow the second cap to be received within the connecting portion of the first cap.

21. The capping system of claim 20, wherein the second cap is connected by way of a snap ring connector.

22. The capping system of claim 20, wherein the second cap is connected by way of a pin and ring connector.

23. The capping system of claim 16, wherein the tether and first cap are made of a flexible resin and the second cap is made of a less flexible resin containing at least 33% glass fiber.

24. A capping system for a container having a valve stem, comprising:
a flexible tether having a first end region, a second opposite end region, and a central region between the first and second end regions;
a first connector in the central region for attaching the tether to the container;
a first cap located in the first end region and sized to frictionally fit over the valve stem; and
a second connector in the second end region; and
a second cap attached to the second connector, the first and second caps being attached to the tether.

25. The capping system of claim 24, wherein the first cap is integrally formed with the tether.

26. The capping system of claim 24, wherein the first cap has first and second ends, the first end being sized to frictionally fit over the valve stem, and the second end including a connecting portion for frictionally attaching the second cap to the first cap.

27. The capping system of claim 24, wherein the second cap is rotatable relative to the second connector.

28. The capping system of claim 26, wherein the second cap is attached to the second connector, and the tether flexes to allow the second cap to be received within the connecting portion of the first cap.

29. The capping system of claim 28, wherein the second cap is connected by way of a snap ring connector.

30. The capping system of claim 28, wherein the second cap is connected by way of a pin and ring connector.

31. The capping system of claim 24, wherein the tether and first cap are made of a flexible resin and the second cap is made of a less flexible resin containing at least 33% glass fiber.
